(19) United States
(12) Patent Application Publication
(10) Pub. No.: US 2009/0272924 A1
(43) Pub. Date: Nov. 5, 2009

(54) SELF-ALIGNING POPPET VALVE ASSEMBLY

(75) Inventors: Paul Wingett, Mesa, AZ (US); Steve Abel, Chandler, AZ (US); Eric J. Ekstrom, Peoria, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/170,142

(22) Filed: Jul. 9, 2008

Related U.S. Application Data
(60) Provisional application No. 61/049,701, filed on May 1, 2008.

(51) Int. Cl. F16K 1/32

(52) U.S. Cl. 251/85; 251/333; 251/363

(57) ABSTRACT

A self-aligning poppet valve assembly is disclosed. The self-aligning poppet valve assembly is disposed within the inner wall of a conduit and comprises a movable sealing member having a poppet guide, a seat portion comprising an inner receptacle adapted to receive the moveable sealing member, a sealing flange adapted to contact the moveable sealing member, thereby selectively inhibiting fluid flow past the moveable sealing member, and a guide receiving portion coupled the poppet guide, and a sealing device surrounding the seat portion and adapted to maintain a seal between the seat portion and the inner wall of the conduit.

### CROSS-REFERENCE TO RELATED APPLICATION(S)

This application claims the benefit of U.S. provisional patent application Ser. No. 61/049,701, filed May 1, 2008.

### TECHNICAL FIELD

Embodiments of the subject matter described herein relate generally to valves and valve assemblies. More particularly, embodiments of the subject matter relate to poppet valves.

### BACKGROUND

Poppet valves are used to control fluid flow, such as in a pressure regulating device. Alignment of the poppet assembly with the seat assembly with which it is coupled to control flow through one or more flow passages can require precise interaction between components. Accordingly, specific dimensioning and tight tolerances is required during manufacture and assembly of the poppet valve to ensure sufficient sealing and movement during operation. Such tolerances can be expensive and time-intensive to produce correctly.

### BRIEF SUMMARY

An apparatus is provided for a self-aligning poppet valve assembly. The self-aligning poppet valve assembly is disposed within the inner wall of a conduit and comprises a movable sealing member having a poppet guide, a seat portion comprising an inner receptacle adapted to receive the moveable sealing member, a sealing flange adapted to contact the moveable sealing member, thereby selectively inhibiting fluid flow past the moveable sealing member, and a guide receiving portion coupled the poppet guide, and a sealing device surrounding the seat portion and adapted to maintain a seal between the seat portion and the inner wall of the conduit.

Another apparatus is provided for a poppet control valve. The poppet control valve is disposed in a conduit having a channel and comprises a movable sealing member having a poppet guide, a seat portion comprising an inner receptacle adapted to receive the moveable sealing member and a guide receiving portion coupled to the poppet guide, and a retention ring disposed in the channel, the retention ring adapted to inhibit movement of the seat portion along the conduit.

Another apparatus is provided for a poppet control valve assembly. The poppet control valve assembly is disposed in a conduit having a channel and comprises a sealing member having a guide protrusion and a seat assembly comprising a protrusion receiving portion at least partially surrounding the guide protrusion and a retention ring disposed in the channel and coupled to the sealing member, the retention ring adapted to inhibit movement of the seat assembly along the conduit, wherein the seat assembly is adapted to center itself along a central axis of the sealing member.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a view of an embodiment of a self-aligning poppet control valve

FIG. 2 is a cutaway perspective view of the embodiment of FIG. 1; and

FIG. 3 is another cutaway perspective view of the embodiment of FIG. 1.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

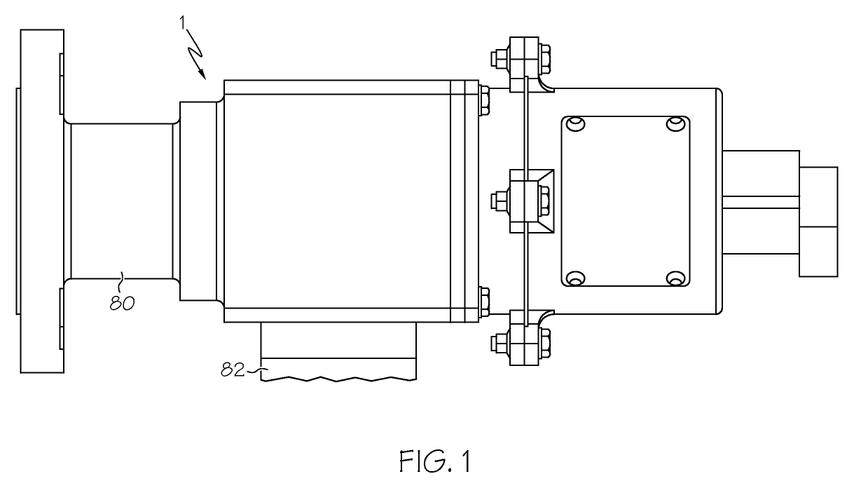

FIGS. 1, 2 and 3 illustrate an embodiment of a self-aligning poppet valve assembly 1. Unless otherwise specified, the elements and components depicted are symmetrical, and the view shown is a cross-sectional view along a vertical plane, near, or along the central axis of the valve assembly 1. FIG. 1 illustrates a view of the poppet valve assembly 1 from outside the intake and outlet conduits 82, 80 in which it is disposed. Fluid flows through the intake conduit 82 toward the poppet valve assembly 1 and controllably through the assembly 1 into the outlet conduit 80.

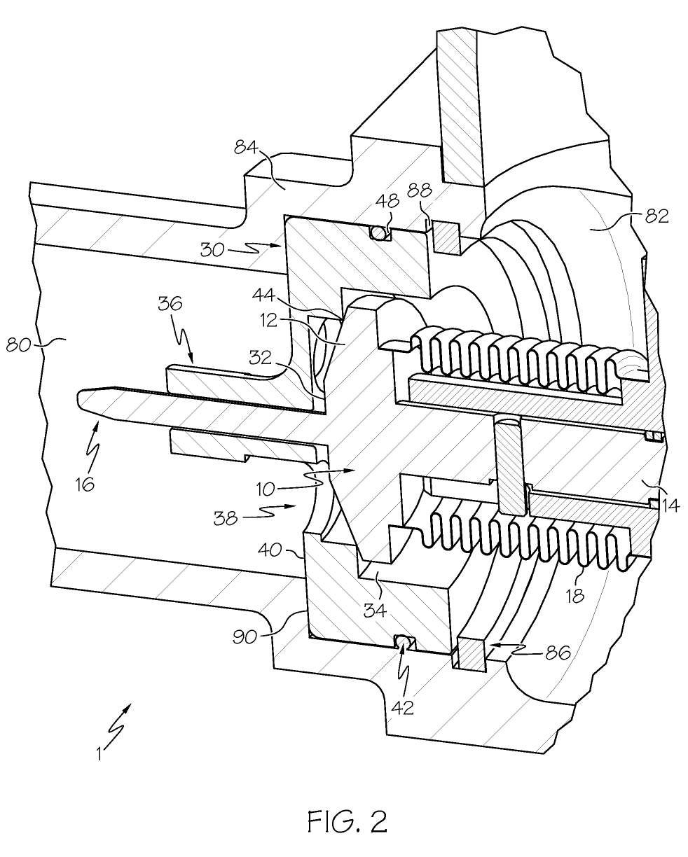

With reference to FIG. 2, the poppet valve assembly 1 comprises a poppet assembly 10 having a disc-shaped flange or sealing member or portion 12, a poppet stem 14, and a poppet guide 16. The poppet assembly 10 can be coupled with a seat assembly 30 having an inner receptacle portion 32, an outer receptacle portion 34, a guide receiving portion 36, and one or more ports 38 through which fluid can flow. The poppet valve assembly 1 can be part of a flow control system. It can be disposed with the poppet valve portion directed toward an outlet conduit 80 and can adjust the flow of fluids from the intake conduit 82 to an outlet conduit 80. In certain embodiments, the direction of flow can be reversed.

The poppet assembly 10 can be composed of a variety of materials, preferably non-corroding metals, such as stainless steel, titanium, aluminum, and the like. The seat assembly 30 can similarly be composed of such metals, or, alternatively, other metals, such as brass.

The seat assembly 30 can be disposed in a valve region 84 between the outlet and intake conduits 80, 82. As shown in FIG. 2, the seat assembly 30 can be larger than one of the conduits' inner diameters; here, the outlet conduit 80. Although the inlet conduit 82 can have an inner diameter larger than the seat assembly 30, preferably, the seat assembly 30 is sized and constructed to nearly contact the inner wall(s) of the valve region 84. The seat assembly 30 can be held in place by a retention or interference ring 86. Although the seat assembly 30 is held in place by the interference ring 86, it can still move relative to the surrounding conduit for purposes of aligning the seat assembly 30 to center around the poppet guide 16, as described below. Thus, some small movement to adjust the position of the seat assembly 30 is contemplated. Nonetheless, the interference ring 86 preferably inhibits axial movement of the seat assembly 30 relative to the conduit, thereby maintaining the effectiveness of its seal. The seat assembly 30 is thus constrained from traveling through the conduit in response to fluid flow and any fluid pressure against it.

The interference ring 86 is preferably positioned to reside in an interference ring channel 88 extending around the circumference of the seat assembly 30, as shown. Thus, the seat assembly 30 can be held in place, or retained, by contact with the smaller-diameter inlet conduit 80 and the interference ring 86. Accordingly, some variation in positioning is possible.

To inhibit fluid from flowing around the seat assembly 30, the seat assembly 30 can have an 0-ring channel 48 around its outer circumference, the O-ring channel 48 appropriately sized to receive an O-ring 42. The O-ring is preferably composed of a material suitable to both inhibit fluid flow around the seat assembly 30 as well as withstand exposure to the fluid. Some such materials can include elastomers such as rubber or silicone and the like. In some embodiments, other sealing members or sealing devices can be used as well, including skirts, flaps, and the like. Thus, although an O-ring is depicted in the illustrated embodiment, other elements are contemplated.

Thus, once the seat assembly 30 is positioned in the valve region 84 and secured by the interference ring 86, fluid is preferably inhibited from flowing from the inlet conduit 82 to the outlet conduit 80. In a closed position, the sealing portion 12 can be contact a portion of the seat assembly 30. As shown in FIG. 2, the contacted area of the seat assembly 30 can be a ledge or flange 44 surrounding the inner receptacle portion 32. Preferably, at least part of the sealing portion 12 can extend into the inner receptacle portion 32. Also preferably, the sealing portion 12 can have an angled head, wherein part of it extends outward in the outer receptacle portion 34 as well.

Fluid flow can be controllably permitted, however, by moving or positioning the sealing portion 12 away from the inner receptacle portion 32. The position of the sealing portion 12 can be adjusted by movement of the poppet stem 14 through coupling with a pneumatic actuator, electromagnetic motor, or other device or component. When the sealing portion 12 is withdrawn from contact with the seat assembly 30, fluid is permitted to flow through the ports 38, past the now-opened sealing portion 12, and into the outlet conduit 82. Although five ports are depicted in the illustrated embodiment, more or fewer about the seat guide portion are possible, from as few as one port to as many as can be practicably disposed in the inner receptacle portion 32.

In some embodiments, the poppet assembly 10 can also include a bellows portion 18 which can cover and insulate some components of the poppet assembly 10 from the surrounding fluid or other conduit environment. Preferably the bellows portion 18 is air- or water-tight and inhibits fluid transfer across its surface, particularly the fluid or fluids present in the inlet or outlet conduits 80, 82. Some components can include a spring, sleeve, or other suitable element. Because the sealing portion 12 is positioned by the poppet stem 14, small deviations in desired placement can occur. As one non-limiting example, the central axis of the sealing portion 12 and poppet stem 14 can be offset from the center or central axis of the inlet conduit 80. Preferably the central axis along which the poppet assembly 10, including the sealing portion 12 and poppet guide 16, extends is a longitudinal axis, as shown. The poppet stem 14 or shaft can extend along the same longitudinal axis.

Precise positioning of the sealing portion 12 relative to the inlet conduit 80 can be expensive and difficult to achieve. Accordingly, an offset between the central axis of the inlet conduit 80 and/or valve region 84 and the central axis of the poppet assembly 10 due to manufacturing or installation tolerances can be sufficient to cause the sealing portion 12 to misalign and improperly seal the valve assembly 1. Such a failure to seal can be caused by poor positioning of the sealing portion 12 against the flange 44. As a result, fluid can uncontrollably flow past the sealing portion 12 when the valve assembly 1 is in the closed position.

Additionally, because the seat assembly 30 is held in place by an interference fit, and because the O-ring 42 can inhibit fluid flow around the seat assembly 30, the dimensions of the inner diameter of the valve region 84 and the outer diameter of the seat assembly 30 can vary slightly. Preferably, the seat assembly 30 is loosely fit, and the interference ring 86 inhibits translation toward the outlet conduit 80, while the O-ring 42 inhibits fluid flow around the seat assembly 30. Because of the lack of fastening features, such as threads, screws, pins, and the like, the placement of the central axis of the seat assembly 30 is preferably variable. The elastomeric features of the O-ring 42 can allow the seat assembly to be positioned offset from the central axis of the outlet portion of the valve region 84 while still inhibiting fluid flow around the seat assembly 30.

Preferably, the position of the seat assembly 30 is directed by the position of the poppet guide 16 of the poppet assembly 10, as coupled to the guide receiving portion 36. Such coupling between the poppet guide 16 and the guide receiving portion 36 causes each component to exert mutual influence or force on the other. The guide receiving portion 36 is preferably rigidly connected or coupled to the other portions of the seat assembly 30, thereby causing relocation of the guide receiving portion 36 to alter or adjust the position of the entire seat assembly 30. Thus, the poppet assembly 10 and, consequently, poppet guide 16 can be offset from the center of the outlet portion of the valve region 84, as described above. However, because the seat assembly 30 can adjust its position, the seal created by the valve assembly 1 in the closed position can be maintained. The seat assembly 30 can therefore adjust itself to permit useful operation of the valve assembly 1 despite variations between the central axes of one component of the assembly 1 to other components. The inherent nature of the valve assembly 1 to properly position the seat assembly 30 in response to such variations can be considered self-aligning. Although the poppet guide 16 is depicted as an elongated circular cross-sectional protrusion in the illustrated embodiment, other guides are also possible, including different geometrical cross sections, and those extending farther or shorter distances past the guide receiving portion 36 and into the outlet conduit 80.

Through natural interaction, the guide receiving portion 36 can exert a reactive force to the poppet guide 16. Preferably, the reactive force is insufficient to undesirably deflect or damage the poppet guide 16 or assembly 10 in any way.

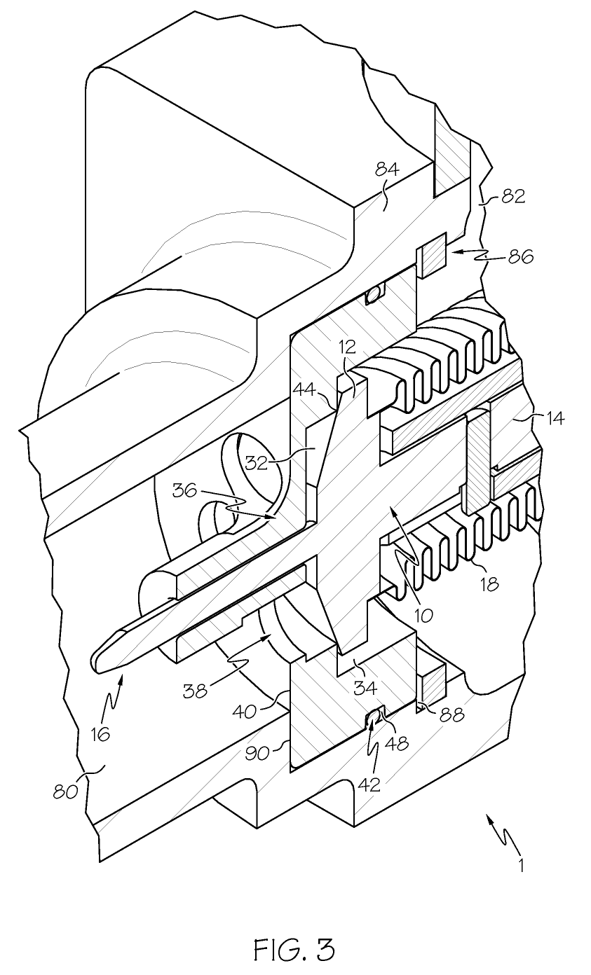

FIG. 3 illustrates the poppet valve assembly 1 from a viewpoint in the direction of the outlet conduit 80. As can be seen, a plurality of ports 38 are present in the inner receptacle 32, permitting fluid to exit the valve assembly 1.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A self-aligning poppet valve assembly disposed within the inner wall of a conduit, the valve assembly comprising:
a movable sealing member having a poppet guide;
a seat portion comprising:
an inner receptacle adapted to receive the moveable sealing member;
a sealing flange adapted to contact the moveable sealing member, thereby selectively inhibiting fluid flow past the moveable sealing member; and
a guide receiving portion coupled the poppet guide; and
a sealing device surrounding the seat portion and adapted to maintain a seal between the seat portion and the inner wall of the conduit.

2. The self-aligning poppet valve assembly of claim 1, wherein the seat portion further comprises a plurality of ports adapted to permit fluid to flow from the conduit into the inner receptacle.

3. The self-aligning poppet valve assembly of claim 1, wherein the moveable sealing member and poppet guide extend along a central longitudinal axis.

4. The self-aligning poppet valve assembly of claim 3, wherein the poppet guide extends along the longitudinal axis beyond the seat portion.

5. The self-aligning poppet valve assembly of claim 3, wherein the moveable sealing member further comprises a shaft extending along the longitudinal axis away from the seat portion.

6. The self-aligning poppet valve assembly of claim 5, wherein the shaft is integrally formed with the moveable sealing member.

7. The self-aligning poppet valve assembly of claim 5, further comprising a bellows at least partially enclosing the shaft.

8. The self-aligning poppet valve assembly of claim 7, wherein the bellows is airtight.

9. A poppet control valve disposed in a conduit having a channel, the poppet control valve comprising:
a movable sealing member having a poppet guide;
a seat portion comprising:
an inner receptacle adapted to receive the moveable sealing member; and
a guide receiving portion coupled to the poppet guide; and
a retention ring disposed in the channel and adapted to inhibit movement of the seat portion along the conduit.

10. The poppet control valve of claim 9, wherein the seat portion further comprises a circumferential channel.

11. The poppet control valve of claim 10, further comprising an o-ring disposed in the circumferential channel.

12. The poppet control valve of claim 9, wherein the movable sealing member further comprises a sealing portion adapted to couple with the inner receptacle to form a seal.

13. The poppet control valve of claim 12, wherein the seat portion further comprises a flange adapted to contact the sealing portion.

14. A poppet control valve assembly disposed in a conduit having a channel, the poppet control valve assembly comprising:
a sealing member having a guide protrusion; and
a seat assembly comprising:
a protrusion receiving portion at least partially surrounding the guide protrusion; and
a retention ring disposed in the channel and coupled to the sealing member, the retention ring adapted to inhibit movement of the seat assembly along the conduit, wherein the seat assembly is adapted to center itself along a central axis of the sealing member.

15. The poppet control valve assembly of claim 14, wherein the seat assembly further comprises a flange adapted to contact the sealing member.

16. The poppet control valve assembly of claim 14, wherein the seat assembly further comprises a channel extending circumferentially at least partially around its outer surface.

17. The poppet control valve assembly of claim 14, wherein the seat assembly further comprises a a sealing device disposed in the channel.

18. The poppet control valve assembly of claim 17, wherein the sealing devices comprises an elastomeric material.
